(19) United States
(12) Patent Application Publication
(10) Pub. No.: US 2003/0154764 A1
(43) Pub. Date: Aug. 21, 2003

(54) Sensor element operated with a preliminary catalysis

(76) Inventors: Roland Stahl, Freiburg (DE); Gerhard Hoetzel, Stuttgart (DE); Harald Neumann, Farmington Hills, MI (US); Johann Riegel, Bietigheim-Bissingen (DE); Lothar Diehl, Stuttgart (DE)

Correspondence Address: KENYON & KENYON, ONE BROADWAY, NEW YORK, NY, 10004, US

(21) Appl. No.: 10/239,121

(22) PCT Filed: Mar. 15, 2001
(86) PCT No.: PCT/DE01/00985

(30) Foreign Application Priority Data
Mar. 21, 2000 (DE) 100 13 882.9

(51) Int. Cl. G01N 7/00

(52) U.S. Cl. 73/23.2

(57) ABSTRACT

The invention describes a sensor element for determining the concentration of gas components in gas mixtures, in particular in exhaust gases of combustion engines, comprising at least one measured gas space (13) and at least one gas inlet opening (17) through which the gas mixture is conveyable to the measured gas space (13), and at least one diffusion barrier (12) arranged between the gas inlet opening (17) and measured gas space (13). The diffusion barrier (12) has at least one region (14, 14a, 16) that contains a catalytically active material for establishing equilibrium in the gas mixture, and is divided into a coarse-pore and a fine-pore portion.

The invention concerns a sensor element of a gas sensor having a means for precatalysis, for determination of gas components in gas mixtures, as defined in the preamble of claim 1.

### BACKGROUND OF THE INVENTION

Amperometric gas sensors for determining the concentration of gas constituents in the exhaust gases of combustion engines are usually operated according to the so-called limiting current principle. A limiting current situation is achieved, however, only if the electrochemical pump cells present in the gas sensor are capable of pumping out of the gas sensor's measured gas space all of the gas to be measured (e.g. oxygen) that is present in the measured gas. In the case of a gas sensor that pumps off oxygen, this must be guaranteed even with an atmospheric oxygen content of approx. 20 vol %. Since the usual electrochemical pump cells used in gas sensors do not have sufficient pumping performance for this, a diffusion barrier is integrated between the gas inlet opening of the sensor element and the measured gas space that contains the electrochemical pump cell. Because of the gas phase diffusion that occurs at this barrier, a concentration gradient forms there between the external gas mixture and the gas atmosphere of the measured gas space. The result of this is that other gas constituents of the gas mixture are also subject to diffusion, and because of their differing diffusion rates a measured gas atmosphere of modified composition is created in the measured gas space of the sensor element.

This has a disadvantageous effect in particular on the measurement accuracy of lambda probes, since the latter measure greatly divergent lambda values when there is an excess of fuel in the exhaust gas (rich exhaust). The reason for this is that the hydrogen present in a rich exhaust has a very high diffusion rate because of its small molecular diameter, and becomes enriched in the measured gas space of the sensor element. If the exhaust gas is exposed to a catalytically active surface before it enters the gas sensor, oxidizing constituents in the exhaust gas react with the hydrogen, and the measurement accuracy of the exhaust gas sensors is appreciably improved.

German Patent DE 37 28 289 C1 describes a gas sensor that contains a diffusion barrier having a platinum content of up to 90 wt %. What is disadvantageous here is principally the large quantity of platinum required therefor, which has a negative effect on the manufacturing costs of the gas sensor.

It is the object of the present invention to make it possible, with small quantities of platinum and without modifying the diffusion behavior of conventional diffusion barriers, to establish an equilibrium in the gas components even before they reach the electrochemical pump cell of the sensor element.

### ADVANTAGES OF THE INVENTION

The gas sensor according to the present invention having the characterizing features of claim 1 has the advantage that gas constituents of a gas mixture can be determined very accurately even with rich combustion mixture settings, despite the oxygen deficiency associated therewith. This is achieved by the fact that the diffusion barrier has an upstream coarse-pore region that contains a catalytically active material, and a fine-pore region that constitutes the actual diffusion resistance. This arrangement allows the gas constituents to react with one another even before they reach the electrochemical pump cell of the sensor element.

The features set forth in the dependent claims make possible additional advantageous developments of and improvements to the sensor element recited in the principal claim. For example, if it is the case not only that the diffusion barrier is preceded by a coarse-pore layer, but also that the entire region between the gas inlet opening and diffusion barrier is filled with a coarse-pore, catalytically active material, the catalytic effect of the layer is further augmented with no appreciable increase in diffusion resistance.

In a further advantageous embodiment, a coarse-pore region that precedes the diffusion barrier and is catalytically active is generated by the fact that a protective layer configured over the electrodes arranged on the large area of the sensor element also additionally covers the gas inlet opening. This is an advantageous solution in particular for the manufacturing process.

### DRAWINGS

Three exemplary embodiments of the invention are depicted in the drawings and explained in more detail in the description which follows.

FIG. 1 is a cross section through the large surface of the sensor element according to the present invention according to a first embodiment

FIG. 2 is a cross section through the large surface of the sensor element according to the present invention according to a second exemplary embodiment.

FIG. 3 is a cross section through the large surface of the sensor element according to the present invention according to a third embodiment.

### EXEMPLARY EMBODIMENTS

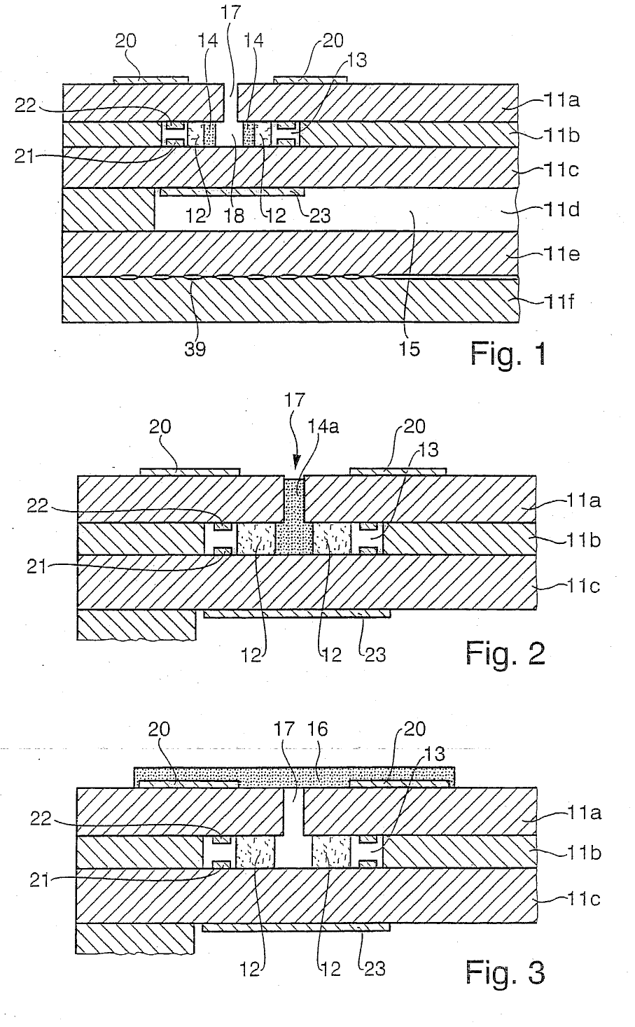

FIG. 1 schematically shows the construction of a first embodiment of the present invention. The number 10 designates a planar sensor element of an electrochemical gas sensor which has, for example, a plurality of oxygen-ion-conducting solid electrolyte layers 11a, 11b, 11c, 11d, 11e, and 11f. Solid electrolyte layers 11a-11f are embodied as ceramic films, and form a planar ceramic body. The integrated form of the planar ceramic body of sensor element 10 is produced in known fashion by laminating together the ceramic films imprinted with functional layers, and then sintering the laminated structure. Each of solid electrolyte layers 11a-11f is made of oxygen-ion-conducting solid electrolyte material, for example ZrO2 partly or completely stabilized with Y203.

Sensor element 10 contains a measured gas space 13 and, for example in a further layer level lid, an air reference conduit 15 that leads out of the planar body of sensor element 10 at one end and communicates with the atmosphere.

Arranged on the large surface of sensor element 10 directly facing the measured gas, on solid electrolyte layer 11a, is an outer pump electrode 20 that can be covered with a porous protective layer (not depicted) and is arranged in annular fashion around a gas inlet opening 17. The associated inner pump electrode 22, which is also embodied in an annular shape matching the annular geometry of measured gas space 13, is located on the side of solid electrolyte layer 11a facing toward measured gas space 13. The two pump electrodes 20, 22 together constitute a pump cell.

Located in measured gas space 13 opposite inner pump electrode 22 is a measurement electrode 21. This is also, for example, embodied in an annular shape. An associated reference electrode 23 is arranged in reference gas conduit 15. The measurement and reference electrodes 21, 23 together constitute a Nernst cell or concentration cell.

To ensure that a thermodynamic equilibrium of the measured gas components is established at the electrodes, all the electrodes used contain a catalytically active material, for example platinum; in a manner known per se, the electrode material for all the electrodes is used as a cement to permit sintering with the ceramic films.

In addition, a resistance heater 39 is embedded between two electrical insulation layers in the ceramic base body of sensor element 10. The resistance heater serves to heat sensor element 10 to the required operating temperature.

Inside measured gas space 13, a porous diffusion barrier 12 precedes inner pump electrode 22 and measurement electrode 21 in the diffusion direction of the measured gas. Porous diffusion barrier 12 constitutes a diffusion resistance with respect to the gas diffusing toward electrodes 21, 22.

As already mentioned above, a basic prerequisite for the functionality of an amperometric gas sensor is that the electrochemical pump cell of the sensor element always be capable, even at high oxygen concentrations, of removing the entire oxygen content from measured gas space 13. The maximum oxygen content occurring in this context is that of the atmosphere, approximately 20 vol %. Since this results in an overload of the electrochemical pump cell, however, a diffusion barrier 12 is placed upstream from measured gas space 13 and thus also from inner pump electrode 22, resulting in a reduction in the oxygen content in measured gas space 13 due to gas-phase diffusion.

The other gas constituents occurring in the exhaust gas are also subject to diffusion, however, and the composition of the gas atmosphere present in measured gas space 13 depends on the diffusion rate of the individual gas components. Especially with a rich exhaust, this results in a great enrichment in hydrogen in measured gas space 13, and thus in a falsified gas sensor reading. The hydrogen content in the exhaust gas can be decreased, however, if the hydrogen is converted on a catalytically active surface with oxidizing gases such as oxygen and carbon dioxide, thus ensuring that a thermodynamic equilibrium is established among the gas constituents.

To bring about this kind of precatalysis, diffusion barrier 12 has a coarse-pore, catalytically active region 14. This precedes diffusion barrier 12 in the flow direction of the gas mixture. The porosity is selected so that only an insignificant diffusion resistance is presented to the incoming gas mixture; the layer thickness nevertheless should not fall below a certain minimum, in order to make possible intensive contact between the gas mixture and the catalytically active surface of the coarse-pore region.

Coarse-pore catalytically active region 14 contains as catalytically active components metals such as Pt, Ru, Rh, Pd, Ir, or a mixture thereof.

During the manufacturing process, either the catalytically active components can be added as a powder to a printing paste from which coarse-pore catalytically active region 14 is produced by means of a printing operation, or catalytic activation can be accomplished by impregnating the already-sintered coarse-pore catalytically active region with a metal salt solution followed by heat treatment in a manner known per se.

FIG. 2 depicts a second embodiment of the sensor element according to the present invention, depicting a portion of the sensor element shown in FIG. 1. In the latter, coarse-pore catalytically active region 14a at least partially surrounds the space preceding diffusion barrier 12; as depicted in FIG. 2, however, it can also occupy the entire region between diffusion barrier 12 and gas inlet opening 17. The resulting increase in the path length of the incoming gases within coarse-pore catalytically active region 14a ensures establishment of a catalytic equilibrium among the gas components. This is important especially because, for example, equilibrium in terms of hydrogen is established only slowly under the conditions present in the exhaust gas.

FIG. 3 depicts a further embodiment of the sensor element according to the present invention, once again depicting a portion of the sensor element shown in FIG. 1.

Outer pump electrode 20 arranged on the large surface of the sensor element is covered with a coarse-pore protective layer 16 that protects the electrode from the entry of solid contaminants, for example soot particles. If protective layer 16 is equipped with catalytically active components and is additionally applied over gas inlet opening 17, the region of protective layer 16 covering gas inlet opening 17 then serves as the coarse-pore region of diffusion barrier 12. This arrangement is characterized by simple manufacture, since an additional process step is not needed.

Since establishment of an equilibrium of the gas components is inhibited by sulfur oxides in the exhaust gas, one or more substances that remove sulfur oxides from the incoming exhaust gas are additionally mixed into coarse-pore catalytically active region 14, 14a, 16. This can be, for example, barium nitrate.

It is explicitly to be noted that the utilization of a catalytically active, coarse-pore region of a diffusion barrier for precatalysis in exhaust gas sensors is not limited to the exemplary embodiments set forth, but rather can also be used in multi-chamber sensors, sensors having several pump cells and concentration cells, or sensors having end-located gas inlet openings. In addition, a coarse-pore catalytically active layer 14, 14a, 16 of this kind can also be arranged after the fine-pore region of diffusion barrier 12.

What is claimed is:

1. A sensor element for determining the concentration of gas components in gas mixtures, in particular in exhaust gases of combustion engines, comprising at least one measured gas space and at least one gas inlet opening through which the gas mixture is conveyable to the measured gas space, and at least one diffusion barrier arranged between the gas inlet opening and measured gas space, the diffusion barrier having at least one region that contains a catalytically active material for establishing equilibrium in the gas mixture,
wherein the diffusion barrier (12) has a coarse-pore and a fine-pore portion.

2. The sensor element as defined in claim 1,
wherein the coarse-pore portion (14, 14a, 16) of the diffusion barrier (12) is located on a side of the diffusion barrier (12) facing toward the gas inlet opening (17), and the fine-pore region on a side of the diffusion barrier (12) facing toward the measured gas space (13).

3. The sensor element as defined in claim 1 or 2, wherein the coarse-pore portion (14, 14a, 16) of the diffusion barrier (12) contains the catalytically active material.

4. The sensor element as defined in one of the foregoing claims,
wherein the coarse-pore portion (14a) of the diffusion barrier (12) substantially fills the gas inlet opening (17).

5. The sensor element as defined in one of the foregoing claims,
wherein the coarse-pore portion (16) of the diffusion barrier (12) is applied on the outer surface of the sensor element exposed to the gas mixture; and the coarse-pore portion (16) of the diffusion barrier (12) covers the gas inlet opening (17) and an outer electrode (20) arranged on the outer surface of the sensor element.

6. The sensor element as defined in one of the foregoing claims,
wherein the coarse-pore portion (14, 14a, 16) of the diffusion barrier (12) contains up to 10 wt %, preferably 2 wt %, of the catalytically active material in very finely distributed form.

7. The sensor element as defined in one of the foregoing claims,
wherein the catalytically active material contains a metal from the group Pt, Ru, Rh, Pd, Ir, or a mixture thereof.

8. The sensor element as defined in one of the foregoing claims,
wherein the diffusion barrier (12) contains a material that removes sulfur oxides from the gas mixture.

9. The sensor element as defined in claim 8,
wherein the material that removes sulfur oxides from the gas mixture is barium nitrate.
